(19) United States
(12) Patent Application Publication
(10) Pub. No.: US 2017/0004281 A1
(43) Pub. Date: Jan. 5, 2017

(54) Prescription Fulfillment User Interface

(71) Applicant: Rite Aid Hdqtrs. Corp., Camp Hill, PA (US)

(72) Inventors: Sharon A. Hartman-Tinder, Ono, PA (US); Scott A. Jacobson, Mechanicsburg, PA (US); Robert Kostosky, Lewisberry, PA (US); Donna M. Litwak, Dillsburg, PA (US); Daniel Miller, Mechanicsburg, PA (US); Shawna L. Mitchell, Mount Wolf, PA (US); Lynne M. Shirk, Lewisberry, PA (US)

(21) Appl. No.: 14/789,530

(22) Filed: Jul. 1, 2015

(51) Int. Cl. G06F 19/00

(52) U.S. Cl. CPC G06F 19/3456

(57) ABSTRACT

A system for aiding a user in fulfillment of a set of prescriptions for a patient includes a user interface. The user interface has a prescription alignment screen that includes a first target date selection button and a second target date selection button. The user interface is configured such that the user can select a first target date and a second target date for the set of prescriptions. The user interface also includes a medication history screen that depicts a patient compliance rating. Additionally, the user interface has an order summary screen. The order summary screen includes contact information associated with the order. The contact information may be contact information of the patient or contact information of a person who is not the patient.

### TECHNICAL FIELD

This disclosure relates generally to a computer user interface for aiding a user in fulfillment of a set of prescriptions for a patient and, more particularly, to aiding a user in aligning prescription fulfillment dates.

### BACKGROUND

Patients often have prescriptions for medications that are refilled on a regular basis, such as monthly. When a patient has more than one prescription that needs to be refilled on a regular basis, doing so may require the patient or the patient's caretaker to make multiple monthly trips to a pharmacy according to when these multiple prescriptions are due to be refilled. Alternatively, mail order pharmacies may need to make multiple monthly shipments to meet a staggered refill schedule. Prescription alignment provides patients and mail order pharmacies a way to minimize or avoid the inconveniences associated with multiple refill schedules. However, prior art systems for aligning prescriptions present challenges for a user, such as a pharmacist, in manipulating data in such a way that provides users and patients with information desired for making decisions about prescription alignment.

### SUMMARY

According to an aspect of the disclosure, a system for aiding a user in fulfillment of a set of prescriptions for a patient includes a user interface. The user interface has a prescription alignment screen that includes a first target date selection button and a second target date selection button. The user interface is configured such that the user can select a first target date and a second target date for the set of prescriptions. The user interface also includes a medication history screen that depicts a patient compliance rating. Additionally, the user interface has an order summary screen. The order summary screen includes contact information associated with the order. The contact information may be contact information of the patient or contact information of a person who is not the patient.

According to another aspect of the disclosure, a system for synchronizing prescription fulfillment for a set of prescriptions for a patient includes a user interface. The user interface is configured to display a first target date juxtaposed to a second target date. The user interface is further configured to display a prescription fulfillment list of the set of prescriptions. The prescription fulfillment list depicts, for each prescription in the set of prescriptions, a number of days between either of the first target date and the second target date and a day on which a next fulfillment for the respective prescription is due. The user interface is also configured to display a prescription history list. The prescription history list includes at least one name of previously-filled prescriptions and a medication compliance rating for the at least one of the prescriptions of the prescription history list. The user interface is also configured to display a patient compliance rating. The patient compliance rating reflects at least one medication compliance rating.

According to another aspect of the disclosure, a method of filling a set of prescriptions for a patient includes entering a first target date in a prescription alignment screen and selecting a first at least one prescription of the set of prescriptions for fulfillment on the first target date in the prescription alignment screen. The method further includes entering a second target date in the prescription alignment screen and selecting a second at least one prescription of the set of prescriptions for fulfillment on the second target date in the prescription alignment screen. Additionally, the method includes selecting a medication history screen. The medication history screen displays a patient compliance rating. The method also includes selecting an order summary screen. The order summary screen displaying contact information associated with the order, the contact information being contact information of the patient or contact information of a person who is not the patient.

### BRIEF DESCRIPTION OF THE DRAWINGS

The foregoing summary, as well as the following detailed description of illustrative embodiments of the methods and systems of prescription fulfillment of the present application, will be better understood when read in conjunction with the appended drawings. For the purposes of illustrating the methods and systems of prescription fulfillment of the present application, there is shown in the drawings illustrative embodiments. It should be understood, however, that the application is not limited to the precise arrangements and instrumentalities shown. In the drawings:

FIG. 1 depicts a screen shot of a prescription alignment screen of a user interface that aids a user in fulfillment of a set of prescriptions according to an embodiment of the invention;

FIG. 2A depicts multiple potential refill schedules for a set of prescriptions refilled on 30, 60, or 90 day periods;

FIG. 2B depicts multiple potential refill schedules for a set of prescriptions refilled on 28, 56, or 84 day periods;

FIG. 3 depicts a screen shot of a medication history screen of the user interface shown in FIG. 1;

FIG. 4 depicts a screen shot of a patient data screen of the user interface shown in FIGS. 1 and 3;

FIG. 5 depicts a screen shot of an order summary screen of the user interface shown in FIGS. 1, 3, and 4;

FIG. 6 depicts an exemplary process for interacting with the user interface;

FIG. 7 depicts an exemplary process for providing compliance packaging using the user interface;

FIG. 8 is a schematic of exemplary compliance packaging; and

FIG. 9 is a block diagram of an example computer system 620 on which embodiments described herein and/or various components thereof may be implemented.

### DETAILED DESCRIPTION OF THE DRAWINGS

Aspects of the disclosure will now be described in detail with reference to the drawings, wherein like reference numbers refer to like elements throughout, unless specified otherwise. Certain terminology is used in the following description for convenience only and is not limiting. Certain features of the disclosure which are described herein in the context of separate embodiments may also be provided in combination in a single embodiment. Conversely, various features of the disclosure that are described in the context of a single embodiment may also be provided separately or in any subcombination.

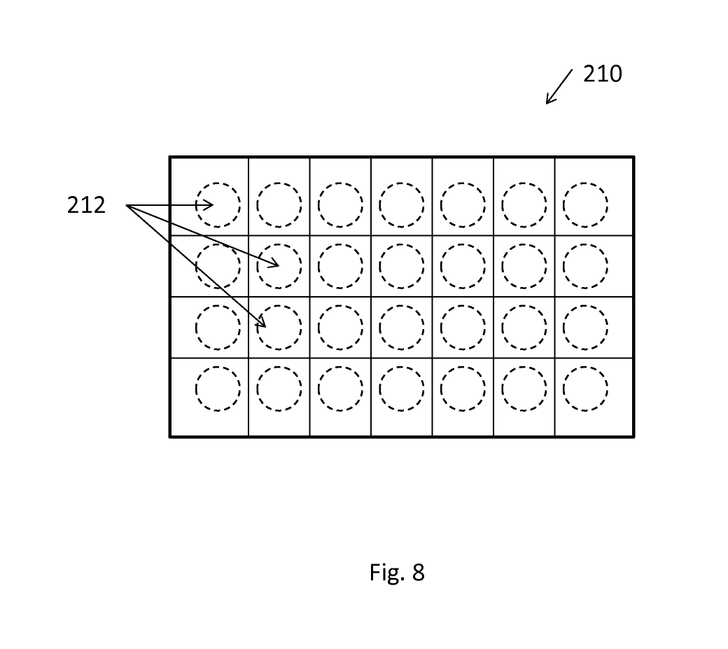

As indicated above, when a patient has more than one prescription that needs to be refilled on a regular basis, doing so may require the patient or the patient's caretaker to make multiple monthly trips to a pharmacy according to when these multiple prescriptions are due to be refilled. Alternatively, mail order pharmacies may need to make multiple monthly shipments to meet a staggered refill schedule. Further, new types of consumer packaging, such as compliance packaging in which multiple prescriptions are packaged together according to a day and time that they are to be taken (for example, in blister packs, shown in FIG. 8 and described in detail below), may be difficult to provide for the patient if the prescriptions have a staggered refill schedule. In order to minimize the need for multiple trips to a pharmacy or multiple monthly package shipments, or in order to provide multiple prescriptions in compliance packaging, the dates on which these multiple prescriptions are refilled may be aligned necessitating only one monthly trip to the pharmacy or one monthly package. Alternatively, prescription fulfillment may be aligned to two or more dates per month in order to distribute prescription costs over a period of time. However, as indicated above, prior art systems for aligning prescriptions present challenges for a user, such as a pharmacist, in manipulating data in such a way that provides users and patients with information desired for making decisions about prescription alignment.

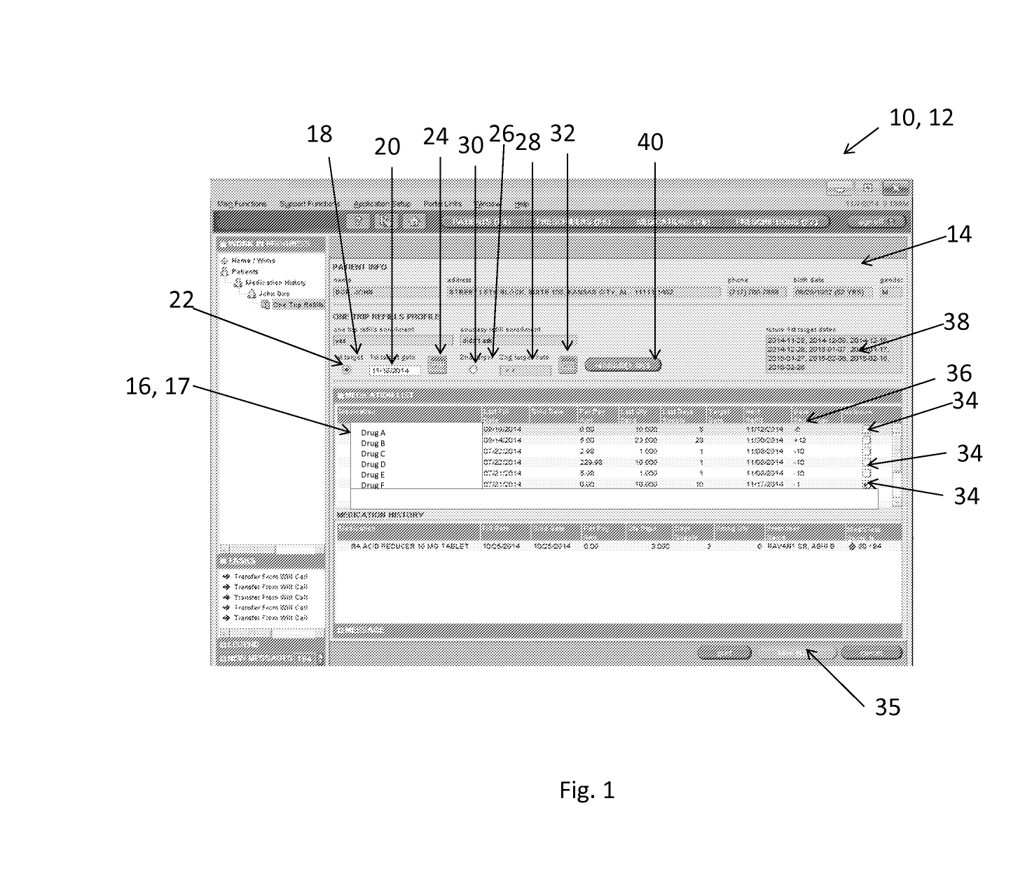

Referring to FIG. 1, an exemplary prescription alignment screen 14 of a user interface 12 for a system 10 for aiding a user, such as a pharmacist, in fulfillment of a set of prescriptions 16 is shown. The set of prescriptions 16 include prescriptions that a patient has been prescribed that require regularly repeated fulfillment. This set of prescriptions 16 are listed in a prescription fulfillment list 17. For example, the patient may have one or more prescriptions needing refill on a monthly basis, such as every 30 days. In other embodiments, the patient may have one or more prescriptions needing refill on a bimonthly basis, such as every 60 days. In still other embodiments, the patient may have one or more prescriptions needing refill on a quarterly basis, such as every 90 days.

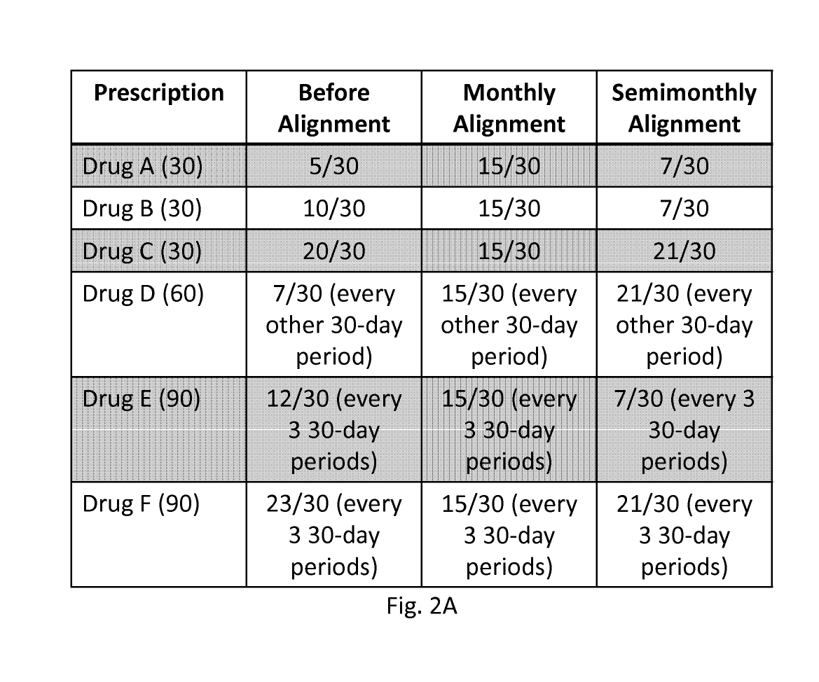

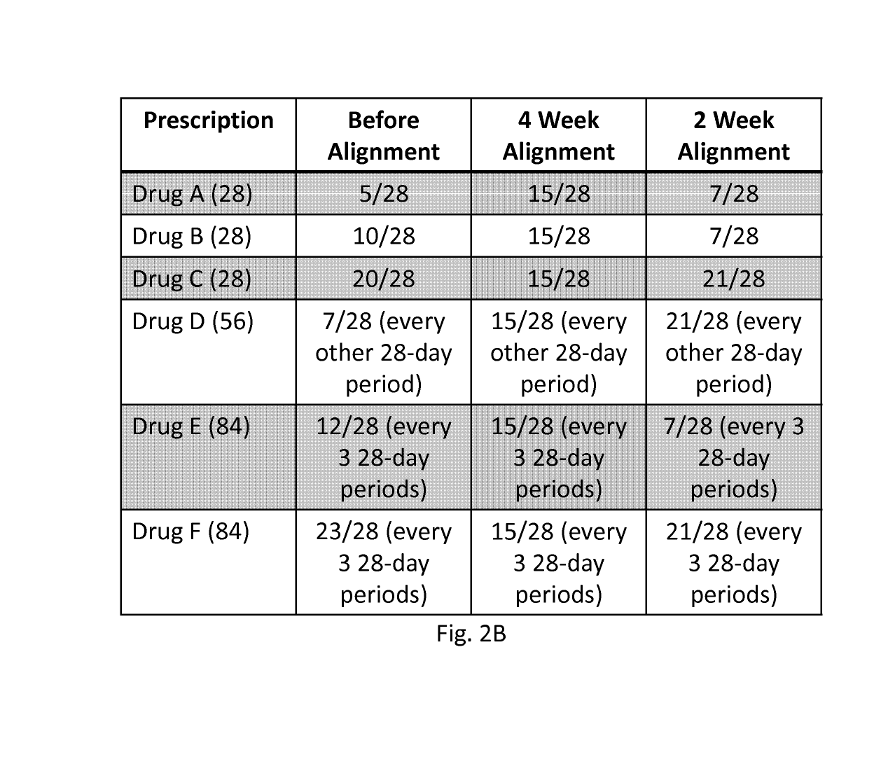

Alternatively, the patient may have a multiple prescriptions that each require fulfillment at different intervals. For example, with reference to FIG. 2A, a patient may have three prescriptions that require fulfillment every 30 days, one prescription requiring fulfillment every 60 days, and 2 prescriptions requiring fulfillment every 90 days. Prior to aligning these prescriptions, these fulfillments may occur on different days relative to a repeating 30-day period. In other words, each of the three prescriptions that require fulfillment every 30 days may require fulfillment on different days of that 30-day period such that Drug A is due for refill on the 5^{th} day of every 30 days. Drug B is due for refill on the 10^{th} day of every 30 days, and Drug C is due for refill on the 20^{th} day of every 30 days. Drug D, which is refilled every 60 days, needs to be refilled on the 7^{th} day of every other 30-day period. Drugs E and F, which are refilled every 90 days, need to be refilled on the 12^{th} and 23^{rd} days of every third 30-day period, respectively.

With continued reference to FIG. 2A, the refill schedule for drugs A, B, C, D, E, and F may be aligned on a monthly or semimonthly basis. If aligned on a monthly basis, Drugs A, B, and C are scheduled for refill on the same day relative to the repeating 30-day period. For example, Drugs A, B, and C may be scheduled for refill on the 15^{th} day of every 30 days. Drug D will be scheduled for refill on the same day that Drugs A, B, and C are scheduled for refill (in this example, the 15^{th} day), but Drug D will only be refilled every other 30-day period. Drugs E and F are rescheduled for the same day that Drugs A, B, C, and D are scheduled for refill (again, the 15^{th} day), but Drugs E and F are only refilled every third 30-day period.

If aligned on a semimonthly basis, Drugs A, B, and C are scheduled for refill on one of two days relative to the repeating 30-day period. For example, Drugs A and B may be scheduled for refill on the 7^{th} day of every 30 days and Drug C may be scheduled for refill on the 21^{st} day of every 30-day period. Drug D will be scheduled for refill on one of the same days that Drugs A, B, and C are scheduled for refill (in this example, the 21^{st} day), but Drug D will only be refilled every other 30-day period. Drugs E and F are rescheduled for one of the same day that Drugs A, B, C, and D are scheduled for refill (the 7^{th} and 21^{st} days, respectively), but Drugs E and F are only refilled every third 30-day period.

The patient may also have prescriptions that are refilled in time intervals that are not multiples of 30 days. For example, with reference to FIG. 2B, the patient may have three prescriptions that require fulfillment every 28 days, one prescription requiring fulfillment every 56 days, and 2 prescriptions requiring fulfillment every 84 days. Prior to aligning these prescriptions, these fulfillments may occur on different days relative to a repeating 28-day period. In other words, each of the three prescriptions that require fulfillment every 28 days may require fulfillment on different days of that 28-day period such that Drug A is due for refill on the 5^{th} day of every 28 days, Drug B is due for refill on the 10^{th} day of every 28 days, and Drug C is due for refill on the 20^{th} day of every 28 days. Drug D, which is refilled every 56 days, needs to be refilled on the 7^{th} day of every other 28-day period. Drugs E and F, which are refilled every 84 days, need to be refilled on the 12^{th} and 23^{rd} days of every third 28-day period, respectively.

With continued reference to FIG. 2B, the refill schedule for drugs A, B, C, D, E, and F may be aligned on a 4-week or 2-week basis. If aligned on a 4-week basis, Drugs A, B, and C are scheduled for refill on the same day relative to the repeating 28-day period. For example, Drugs A, B, and C may be scheduled for refill on the 15^{th} day of every 28 days. Drug D will be scheduled for refill on the same day that Drugs A, B, and C are scheduled for refill (in this example, the 15^{th} day), but Drug D will only be refilled every other 28-day period. Drugs E and F are rescheduled for the same day that Drugs A, B, C, and D are scheduled for refill (again, the 15^{th} day), but Drugs E and F are only refilled every third 28-day period.

If aligned on a 2-week basis, Drugs A, B, and C are scheduled for refill on one of two days relative to the repeating 28-day period. For example, Drugs A and B may be scheduled for refill on the 7^{th} day of every 28 days and Drug C may be scheduled for refill on the 21^{st} day of every 28-day period. Drug D will be scheduled for refill on one of the same days that Drugs A, B, and C are scheduled for refill (in this example, the 21^{st} day), but Drug D will only be refilled every other 28-day period. Drugs E and F are rescheduled for one of the same day that Drugs A, B, C, and D are scheduled for refill (the 7^{th} and 21^{st} days, respectively), but Drugs E and F are only refilled every third 28-day period. The user saves the alignment schedule by pressing the save orders button 35.

Referring again to FIG. 1, in order to align the patient's prescriptions (such as Drugs A, B, C, D, E, and F) onto a 4-week schedule or a monthly schedule, the user enters a first target date 20 (such as the 15^{th} day of the 28 or 30-day period) using the first target date selection button 18. The first target date selection button 18 may include the first target date 20, an activation icon 22, and a calendar pop-up icon 24. In order to align the patient's prescriptions onto a semimonthly schedule, the user also enters a second target date 28 (such as the 7^{th} or the 21^{st} day of the 28 or 30-day period) using the second target date selection button 26. The second target date selection button 26 includes the second target date 28, an activation icon 30, and a calendar pop-up icon 32. In some embodiments, the prescription alignment screen may include a third target date selection button (not shown) in addition to the first target date selection button 18 and the second target date selection button 26. The user interface 12 may be configured such that the user can select a third target date, in addition to two other dates for the set of prescriptions 16. Other embodiments may further include a fourth target date selection button (not shown) in addition to the first target date selection button 18, the second target date selection button 26, and the third target date selection button. The user interface 12 may be configured such that the user can select four target dates for the set of prescriptions 16.

For example, in order to align the set of prescriptions 16, including Drugs A, B, C, D, E, and F, to a 4-week or monthly schedule, the user presses the prescription selection button 34 in the prescription fulfillment list 17 for each of the prescriptions to be aligned. The user also enters the first target date 20 using the first target date selection button 18. For example, the user can manually enter the first target date 20. Alternatively, the user can press the calendar pop-up icon 24 and select the first target date 20 from the pop-up calendar (not shown). When the first target date 20 is entered, the activation icon 22 may automatically indicate that the first target date 20 is activated. Alternatively, a user may need to press the activation icon 22 in order to activate the first target date 20.

In another example, in order to align the set of prescriptions 16, including Drugs A, B, C, D, E, and F, to a 2-week or semimonthly schedule, the user presses the prescription selection button 34 in the prescription fulfillment list 17 for each of the prescriptions to be aligned to a first target date 20 (leaving those to be aligned to a second target date unselected). The user also enters the first target date 20 using the first target date selection button 18. For example, the user can manually enter the first target date 20. Alternatively, the user can press the calendar pop-up icon 24 and select the first target date 20 from the pop-up calendar (not shown). When the first target date 20 is entered, the activation icon 22 may automatically indicate that the first target date 20 is activated. Alternatively, a user may need to press the activation icon 22 in order to activate the first target date 20.

Aligning the set of prescriptions 16 to a schedule with multiple target dates may be advantageous for the patient on multiple levels. On a first level, a multiple target date schedule may be used to distribute costs of medications throughout a period of time (e.g., a month or every four weeks). Multiple target dates may also be used when a patient has multiple prescriptions that are refilled on different schedules. For example, with reference again to FIGS. 2A and 2B, a patient may have a set of prescriptions that are refilled every 30 days (or a multiple thereof) and another set of prescriptions that are refilled every 28 days (or a multiple thereof). Using two target dates, the set of prescriptions needing refill every 30 days (or multiple thereof) may be aligned to a first target date, while the set of prescriptions needing refill every 28 days (or multiple thereof) may be aligned to a second target date. In another example, if a patient also has a third set of prescriptions that require refill on a schedule that is not based on 28 or 30 days, a third target date may be used to align the third set of prescriptions.

In order to align the remaining prescriptions of the set of prescriptions 16 to a second target date, the user presses the prescription selection button 34 in the prescription fulfillment list 17 for each of the prescriptions to be aligned to the second target date 28. The user also enters the second target date 28 using the second target date selection button 26. For example, the user can manually enter the second target date 28. Alternatively, the user can press the calendar pop-up icon 32 and select the second target date 28 from the pop-up calendar (not shown). When the second target date 28 is entered, the activation icon 22 may automatically indicate that the second target date 28 is activated. Alternatively, a user may need to press the activation icon 30 in order to activate the second target date 28.

When a prescription is selected for alignment to either of the first target date 20 or the second target date 28, the prescription fulfillment list 17 depicts for each prescription in the set of prescriptions 16 a number of days 36 between either of the first target date and the second target date and a day on which a next fulfillment for the respective prescription is due. For example, if Drug A is being aligned from the 5^{th} day of every 28 or 30-day period to the 15^{th} day, there would be a negative 10 day gap as depicted by the number of days 36. For Drug C, which is being aligned from the 20^{th} day of every 28 or 30-day period to the 8^{th} day, there would be a positive 12 day gap as depicted by the number of days 36. The calculation of these gaps provides for the user to be able to adjust the amounts so that the patient is not provided with too many or too few doses. For example, the user may provide the patient with a shortened day supply to cover the 10 day gap between when Drug A is due for refill prior to alignment and the new aligned date. Additionally, the user may provide the patient with less than a full refill for Drug C to account for the 12 day surplus supply that the patient would otherwise receive.

The prescription alignment screen further includes a list of future target dates 38 based on the first target date 20 or the first target date 20 and the second target date 28. Information about future target dates 38 may be useful to the user in order to assist the patient in planning for picking up future prescription refills.

The prescription alignment screen 14 further includes a recalculation button 40. When either of the first target date 20 and the second target date 28 are revised, or when the second target date 28 is entered for the first time, the recalculation button 38 prompts the user interface 12 to update number of days 36 between either of the first target date and the second target date and a day on which a next fulfillment for the respective prescription is due and the list of future target dates 38.

The prescription fulfillment list 17 also includes additional information to assist the user in helping the patient to decide how to align the patient's set of prescriptions 16. For example, the prescription fulfillment list 17 may include for each prescription, the date the prescription was last filed, the amount paid for the last fulfillment, the last quantity dispensed, the last days' supply provided, and the next refill due date.

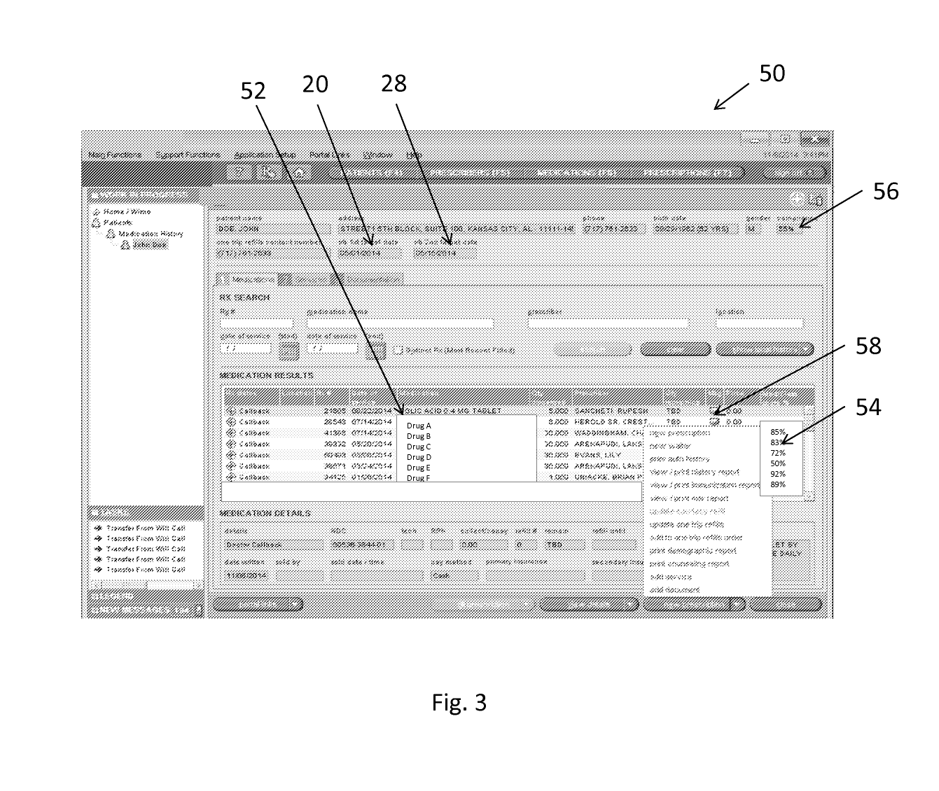

With reference to FIG. 3, the user interface further includes a medication history screen 50. The medication history screen 50 includes a prescription history list 52 that lists the names of previously-filled prescriptions. The prescription history list 52 may also include additional information such as a medication compliance rating 54. The medication compliance rating reflects a patient's timeliness in picking up a prescription refill for a particular drug. For example, if a patient always picks up a prescription refill for a particular drug on time, such that the patient has the proper number of dosages available at all time, the medication compliance rating 54 for that particular drug would be 100%. If, on the other hand, the patient did not pick up prescription refills for that particular drug in a timely manner, such that the patient must necessarily have skipped dosages, the medication compliance rating 54 would be less than 100%.

The medication history screen 50 may also depict a patient compliance rating 56. The patient compliance rating 56 reflects, at least in part, the medication compliance rating 54 for each of the drugs in the prescription history list 52 that has a medication compliance rating 54. In this way, the patient compliance rating 56 reflects the overall pattern in which the patient obtains refilled prescriptions. The medication compliance rating 54 and the patient compliance rating 56 may assist the user in helping the patient to determine if prescription alignment might be a good idea. The medication compliance rating 54 and the patient compliance rating 56 may also help the user to alert the patient to compliance issues with missing dosages.

The medication history screen 50 may also include other information. For example, the prescription history list 52 may include the last quantity dispensed and the quantity remaining for drugs listed in the prescription history list. Further, the prescriber and prescription number may be included in the prescription history list 52. Additionally, the prescription history list may include a message icon 58 that provides the user with an indication about whether a message with sent to the patient regarding a problem with the prescription or if communication to the patient regarding fulfillment of the prescription failed. The medication history screen 50 may also display additional information about the patient, such as contact information and copay amount. Further, the medication history screen 50 may display the first target date 20 and the second target date 28.

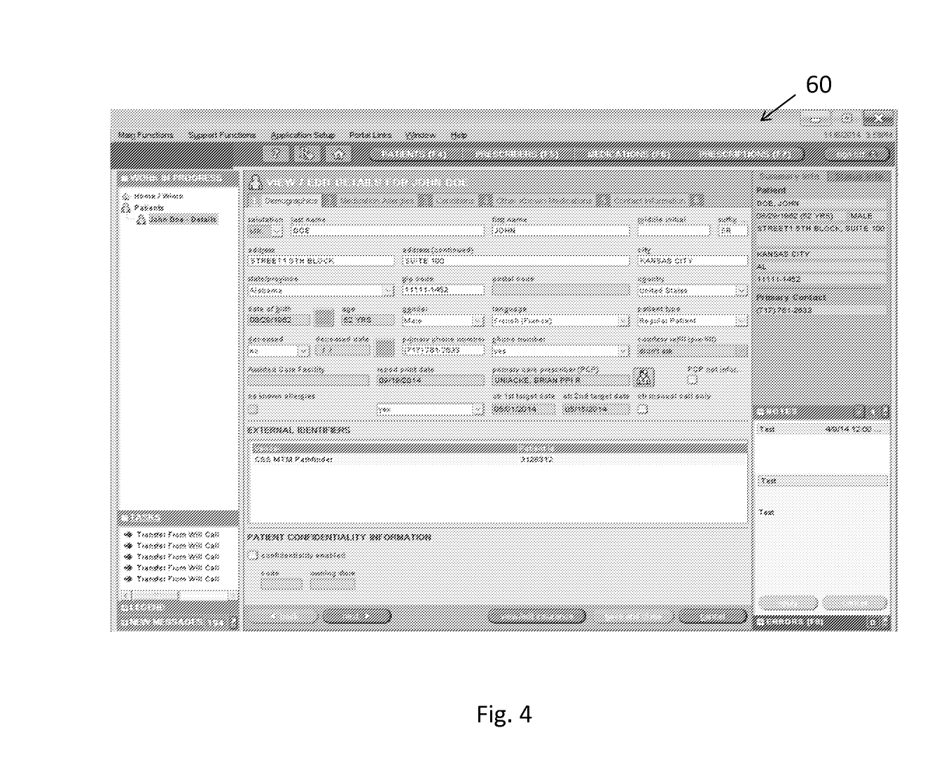

Referring to FIG. 4, the user interface 12 may include a patient data screen 60. The patient data screen 60 may include information about the patient, such as the patient's name, age, address, and phone number. The patient data screen may include additional information such as the name of the patient's primary care prescriber, the name of the facility in which the patient is located, and whether the patient is enrolled in any prescription fulfillment services.

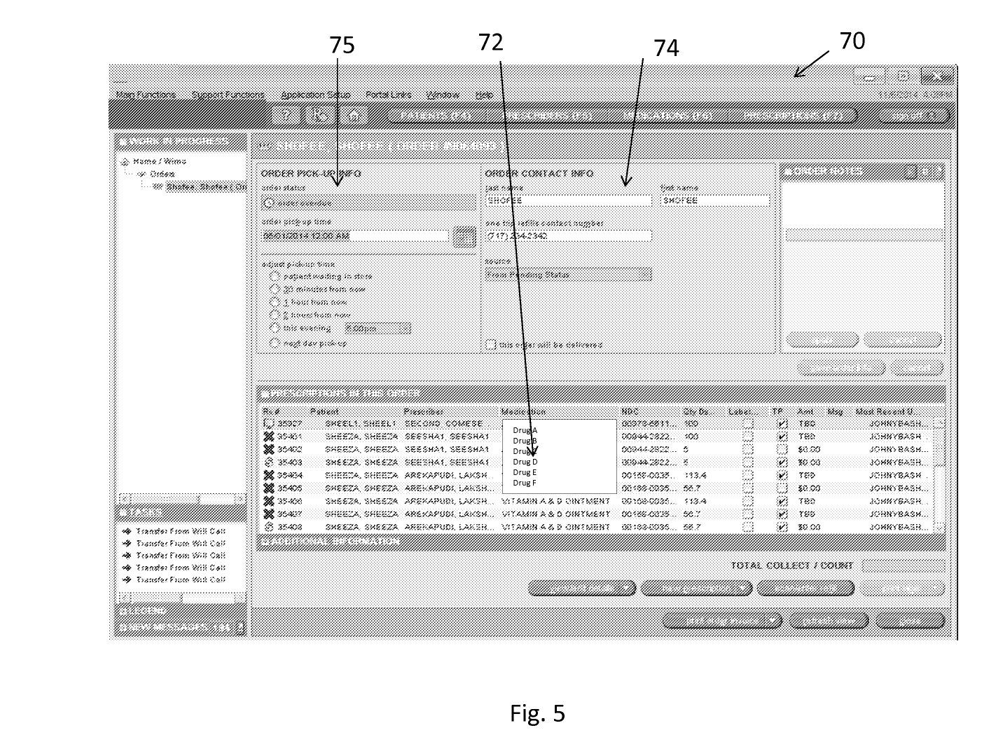

Referring now to FIG. 5, the user interface 12 may also include an order summary screen 70. The order summary screen 70 depicts an ordered prescription list 72 that includes the prescriptions of the set of prescriptions 16 that have been included in the order shown on the order summary screen 70. The ordered prescription list 72 may include the name of the patient, the name of the prescriber, the name of the medication, the quantity of the medication, and the cost of the medication. The order summary screen may also show contact information 74 associated with the order. The contact information 74 may be the contact information of the patient (as shown in patient data screen 60) or contact information of a person who is not the patient.

The order summary screen 70 may also include pick-up status information. For example, the user can use a pick-up status icon 75 to select and/or adjust a pick-up time for the order. The order summary screen can also show if the order is overdue for pick-up.

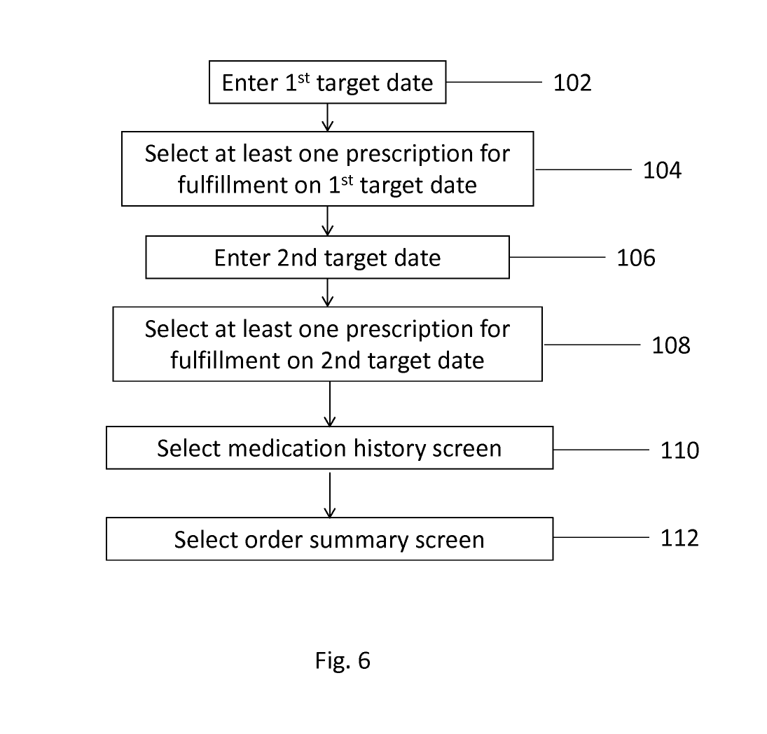

With reference now to FIG. 6, an exemplary process is shown for using the user interface 12 to align the set of prescriptions 16 according to two target dates, such as a 2-week or semimonthly schedule. To align a first at least one prescription of the set of prescriptions 16, the user enters the first target date 20 at step 102 using the first target date selection button 18. At step 104, the user presses the prescription selection button 34 in the prescription fulfillment list 17 for each of the prescriptions to be aligned to the first target date 20 (leaving those to be aligned to a second target date unselected). In order to align a second at least one prescription of the set of prescriptions 16 to a second target date, at step 106, the user enters the second target date 28 using the second target date selection button 26. At step 108, the user presses the prescription selection button 34 in the prescription fulfillment list 17 for each of the prescriptions to be aligned to the second target date 28. The user then presses save order button 35 in order to save the selections. At step 110, the user selects the medication history screen 50 which shows at least one of the patient compliance rating 56, the prescription history list 52, patient contact information, the first target date 20, and the second target date 28. At step 112, the user selects the order summary screen 70 which shows at least one of the ordered prescription list 72, the name of the patient, the name of the prescriber, the name of the medication, the quantity of the medication, the cost of the medication, contact information 74 associated with the order, and pick-up status information.

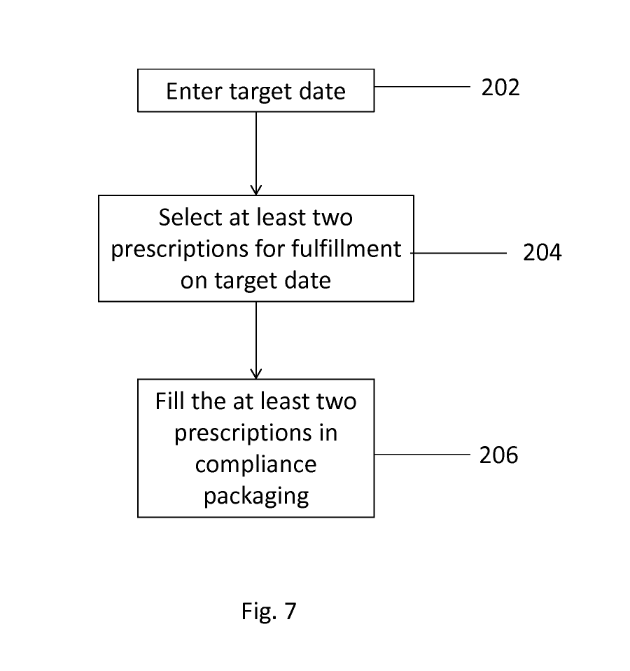

With reference now to FIGS. 7 and 8, an exemplary process for providing compliance packaging 210 using the user interface 12 is described. An example of compliance packaging 210 is shown in FIG. 8. The compliance packaging 210 includes multiple single use packages 212 that are configured to hold single doses of multiple prescriptions. As shown in FIG. 8, compliance packaging 210 includes a 28-day supply of medications taken once daily. For example, if the patient requires one dose each or three prescriptions, each single use package contains one of each of the three prescriptions. In order to align these prescriptions for fulfillment on the same day of a 28-day cycle so as to be able to provide the prescriptions in compliance packaging 210, at step 202, the user enters the target date 20 at step 102 using the first target date selection button 18. At step 204, the user presses the prescription selection button 34 in the prescription fulfillment list 17 for each of the prescriptions (in this example, three) to be aligned to the target date 20 and included in the compliance packaging 210. The user than fills these prescriptions into the compliance packaging 210.

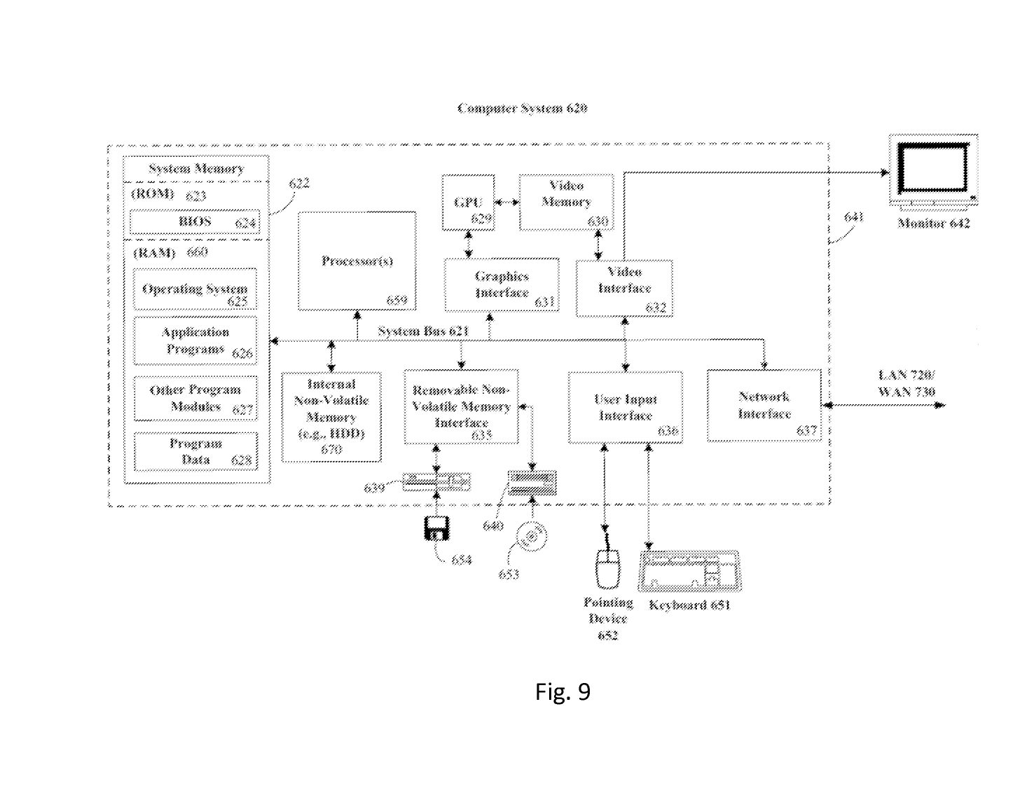

FIG. 9 is a block diagram of an example computer system 620 on which the embodiments described herein and/or various components thereof may be implemented. For example, the functions performed by the entities described in the various embodiments above may be performed by one or more such example computer systems. For example, information system may be implemented in software (i.e., computer executable instructions or program code) executing on one or more such computer systems 620. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 9. In some embodiments, the various depicted computing elements may include modules or components configured to instantiate specific aspects of the present disclosure. For example, the terms “module” or “component” used in this description may include specialized hardware components configured to perform function(s) by firmware or switches. In other example embodiments, the terms “module” and “component” may include a general purpose processor, memory, etc., configured by software instructions that embody logic operable to perform function(s). In example embodiments where modules or components include a combination of hardware and software, an implementer may write source code embodying logic and the source code may be compiled into machine readable code that can be processed by the general purpose processor. Since the state of the art has evolved to a point where there is little difference between hardware, software, and a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 9, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 9 illustrates operating system 625, application programs 626, other program modules 627, and program data 628. As a further example, video content (e.g. video frames) and/or metadata (e.g. closed caption data), in one embodiment, may be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, solid-state drives, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, and illustrated in FIG. 9, may provide storage of computer readable instructions, data structures, program modules and other data for the computer 641.

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation a floppy diskette, CD-ROM, CD-RW, DVD-ROM, DVD-RAM, magnetic tape, flash memory, solid-state drive, hard disk drive, or any other machine-readable storage medium, wherein, when the program code is loaded into and executed by a machine, such as a computer or server, the machine becomes an apparatus for practicing the invention. A computer on which the program code executes may include a processor, a storage medium readable by the processor (including volatile and/or non-volatile memory and/or storage elements), at least one input device, and/or at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits. As used herein, the terms “computer-readable medium” and “computer-readable storage medium” do not include a transient signal.

Features of the disclosure which are described above in the context of separate embodiments may be provided in combination in a single embodiment. Conversely, various features of the disclosure that are described in the context of a single embodiment may also be provided separately or in any subcombination.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the claims.

What is claimed:

1. A system for aiding a user in fulfillment of a set of prescriptions for a patient, the system comprising:
a user interface, the user interface comprising:
a prescription alignment screen that includes a first target date selection button and a second target date selection button, the user interface configured such that the user can select a first target date and a second target date for the set of prescriptions;
a medication history screen that includes a patient compliance rating; and
an order summary screen, the order summary screen including contact information associated with the order, the contact information being contact information of the patient or contact information of a person who is not the patient.

2. The system of claim 1, wherein the prescription alignment screen further includes a prescription fulfillment list of the set of prescriptions, the prescription fulfillment list depicting for each prescription in the set of prescriptions a number of days between either of the first target date and the second target date and a day on which a next fulfillment for the respective prescription is due.

3. The system of claim 2, wherein the prescription alignment screen further includes future target dates based on at least one of the first target date and the second target date.

4. The system of claim 3, wherein the prescription alignment screen further includes a recalculation button and the user interface configured such that the user can revise either of the first target date and the second target date and press the recalculation button and the prescription alignment screen will depict:
for each prescription in the set of prescriptions a revised number of days between either of the first target date and the second target date and a day on which a next fulfillment for the respective prescription is due; and
revised future target dates.

5. The system of claim 2, wherein the prescription alignment screen further includes a prescription selection button for each prescription of the set of prescriptions, the user interface configured such that the user can select at least one prescription of the set of prescriptions for inclusion into prescription alignment for either of the first target date or the second target date.

6. The system of claim 1, wherein the prescription alignment screen further includes a prescription history list, the prescription history list including at least one name of previously-filled prescriptions and a medication compliance rating for at least one of the prescriptions of the prescription history list.

7. The system of claim 1, wherein the prescription alignment screen further includes a third target date selection button, the user interface configured such that the user can select a third target date for the set of prescriptions.

8. The system of claim 1, wherein the medication history screen further includes a prescription history list, the prescription history list including at least one name of previously-filled prescriptions and a medication compliance rating for at least one of the prescriptions of the prescription history list.

9. A system for synchronizing prescription fulfillment for a set of prescriptions for a patient, the system comprising:
a user interface, the user interface configured to display:
a first target date juxtaposed to a second target date;
a prescription fulfillment list of the set of prescriptions, the prescription fulfillment list depicting for each prescription in the set of prescriptions a number of days between either of the first target date and the second target date and a day on which a next fulfillment for the respective prescription is due;
a prescription history list, the prescription history list including at least one name of previously-filled prescriptions and a medication compliance rating for at least one of the prescriptions of the prescription history list; and
a patient compliance rating, the patient compliance rating reflecting at least one medication compliance rating.

10. The system of claim 9, wherein the user interface includes a first target date selection button and a second target date selection button, and the user interface is configured such that the user can select a first target date and a second target date for the set of prescriptions is configured such that the user can select the first target date and the second.

11. The system of claim 9, wherein the user interface is further configured to display future target dates based on at least one of the first target date and the second target date.

12. The system of claim 11, wherein the user interface includes a recalculation button and the user interface is configured such that the user can revise either of the first target date and the second target date and press the recalculation button and the user interface will display:
for each prescription in the set of prescriptions a revised number of days between either of the first target date and the second target date and a day on which a next fulfillment for the respective prescription is due; and
revised future target dates.

13. The system of claim 9, wherein the user interface is further configured to display a prescription selection button for each prescription of the set of prescriptions, and the user interface is also configured such that the user can select at least one prescription of the set of prescriptions for inclusion into prescription alignment for either of the first target date or the second target date.

14. The system of claim 9, wherein the user interface is further configured to display a third target date juxtaposed to the first target date and the second target date.

15. A method of interacting with a user interface presented on a display device for filling a set of prescriptions for a patient, the method comprising:
entering a first target date in a prescription alignment screen within the user interface;
selecting a first at least one prescription of the set of prescriptions for fulfillment on the first target date in the prescription alignment screen;
entering a second target date in the prescription alignment screen;
selecting a second at least one prescription of the set of prescriptions for fulfillment on the second target date in the prescription alignment screen;
selecting a medication history screen within the user interface, the medication history screen displaying a patient compliance rating; and
selecting an order summary screen within the user interface, the order summary screen displaying contact information associated with the order, the contact information being contact information of the patient or contact information of a person who is not the patient.

16. The method of claim 15 wherein, subsequent to either the step of entering the first target date or entering the second target date, the prescription alignment screen displays a prescription fulfillment list of the set of prescriptions, the prescription fulfillment list depicting for each prescription in the set of prescriptions a number of days between either of the first target date and the second target date and a day on which a next fulfillment for the respective prescription is due.

17. The method of claim 16 wherein, subsequent to either the step of entering the first target date or entering the second target date, the prescription alignment screen displays future target dates based on at least one of the first target date and the second target date.

18. The method of claim 17, further comprising steps of entering a revised first target date in the prescription alignment screen and selecting a recalculation button, wherein subsequent to the step of selecting the recalculation button, the prescription alignment screen depicts for each prescription in the set of prescriptions a revised number of days between either of the first target date and the second target date and a day on which a next fulfillment for the respective prescription is due; and revised future target dates.

19. The method of claim 20, further comprising steps of entering a third target date in the prescription alignment screen and selecting a third at least one prescription of the set of prescriptions for fulfillment on the third target date in the prescription alignment screen.

20. A method of providing compliance packaging for a patient, the method comprising:
entering a target date in a prescription alignment screen within the user interface;
selecting at least two prescriptions of a set of prescriptions for fulfillment on the target date in the prescription alignment screen; and
filling the at least two prescriptions in compliance packaging in which doses of the at least two prescriptions are packaged together in single use packages, each single use package consisting of a single dose of each of the at least two prescriptions.
